(19) United States
(12) Patent Application Publication
(10) Pub. No.: US 2026/0238631 A1
(43) Pub. Date: Aug. 13, 2026

(54) INTEGRATED MASTER DIGITAL ACCESS PLATFORM FOR VEHICLE

(71) Applicant: GM GLOBAL TECHNOLOGY OPERATIONS LLC, Detroit, MI (US)

(72) Inventors: Azin Neishaboori, Plymouth, MI (US); Venkata Naga Siva Vikas Vemuri, Farmington Hills, MI (US); Ahmed F. Al Alawy, Canton, MI (US); Mohamed A. Layouni, Macomb, MI (US)

(73) Assignee: GM GLOBAL TECHNOLOGY OPERATIONS LLC, Detroit, MI (US)

(21) Appl. No.: 19/047,865

(22) Filed: Feb. 7, 2025

(51) Int. Cl. H04L 9/40

(52) U.S. Cl. CPC H04L 63/0823

(57) ABSTRACT

A system of authenticated digital access for a vehicle includes a controller installed in the vehicle. The controller has a processor and tangible, non-transitory memory on which instructions are recorded. The controller is adapted to selectively execute a master access platform for vehicle authentication and providing user access. The master access platform includes a first digital key and a second digital key. The first digital key is configured to enable access to a predetermined service in at least one ecosystem external to the vehicle. The second digital key is configured to enable access to at least one connected unit in the vehicle. The respective access privileges of each digital key in the master access platform are verified based in part on at least one metadata entry.

### INTRODUCTION

The present disclosure relates to a vehicle with an integrated digital access key chain and a corresponding method. The number and variety of smart devices and connected systems has grown tremendously over recent times. The technology has led to an increase in communications between various entities, such as individual devices and infrastructure, and the need for device identification and authentication methods. Mobile devices are frequently employed for individual authentication and credential sessions in the communications between entities. This has led to greater cloud and cellular congestion.

### SUMMARY

Disclosed herein is a system of authenticated digital access for a vehicle. The system includes a controller installed in the vehicle, the controller having a processor and tangible, non-transitory memory on which instructions are recorded. The controller is adapted to selectively execute a master access platform for vehicle authentication and providing user access. The master access platform includes a first digital key and a second digital key. The first digital key is configured to enable access to a predetermined service in at least one ecosystem (“at least one” omitted henceforth) external to the vehicle. The second digital key is configured to enable access to at least one connected unit in the vehicle. The respective access privileges of each digital key in the master access platform are verified based in part on at least one metadata entry.

The second digital key may be configured to enable access to a second predetermined service in a second ecosystem external to the vehicle. In some embodiments, the ecosystem includes at least one of a charging station, a road-side unit, and a tolling system. The ecosystem may include at least one of a smart home garage system, and a parking system. The ecosystem may include another vehicle. The controller may be adapted to present the first digital key to the ecosystem via a contactless mechanism.

The controller may be adapted to receive a basic vehicle certificate from a certification authority during an initial vehicle pairing and transmit an access request for the predetermined service to the ecosystem with the basic vehicle certificate. The access request includes the predetermined service from the ecosystem.

In some embodiments, the controller is adapted to receive an embedded vehicle certificate from the ecosystem, the ecosystem having forwarded the basic vehicle certificate to the certification authority (prior to this) with access requirements for the predetermined service valid up to an expiration date. Here, the controller is adapted present the embedded vehicle certificate for future interactions with the ecosystem up to the expiration date. The embedded vehicle certificate includes the at least one metadata entry inserted by the certification authority incorporating the predetermined service and the expiration date.

In some embodiments, the controller is adapted to receive a token issued by the ecosystem, and present the token for future interactions with the ecosystem up to the expiration date. The token includes a metadata entry inserted by the ecosystem incorporating the predetermined service and an expiration date

The controller may be adapted to communicate with a broker in accordance with a publish-subscribe messaging protocol and select the predetermined service from a list of subscription suggestions provided by the broker. The publish-subscribe messaging protocol may include Message Queue Telemetry Transport (MQTT). In some embodiments, the controller is adapted to employ a credential selection for the ecosystem based in part on an involvement level of the ecosystem, which includes direct involvement and partial involvement.

Disclosed herein is a method for authenticated digital access in a vehicle having a controller with a processor and tangible, non-transitory memory on which instructions are recorded, and at least one connected unit adapted to interface with the controller. The method includes selectively executing a master access platform for vehicle authentication and providing user access, the master access platform including a first digital key and a second digital key. The method includes obtaining access to a predetermined service in at least one ecosystem external to the vehicle through the first digital key. The method includes obtaining access to the at least one connected unit through the first digital key and verifying respective access privileges of each digital key in the master access platform based in part on at least one metadata entry.

Disclosed herein is a vehicle having a controller with a processor and tangible, non-transitory memory on which instructions are recorded. At least one connected unit is adapted to interface with the controller. The controller is adapted to selectively execute a master access platform for vehicle authentication and providing user access, the master access platform including a first digital key and a second digital key. The first digital key is configured to enable access to a predetermined service in at least one ecosystem external to the vehicle. The second digital key is configured to enable access to the at least one connected unit. Respective access privileges of each digital key in the master access platform are verified based in part on at least one metadata entry.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic fragmentary diagram of a system of authenticated digital access for a vehicle;

FIG. 2 is a flowchart for an example method of operating the system of FIG. 1, in accordance with a first embodiment;

FIG. 3 is a flowchart for an example method of operating the system of FIG. 1, in accordance with a second embodiment; and

FIG. 4 is a schematic diagram of an example architecture employable by the system of FIG. 1.

Representative embodiments of this disclosure are shown by way of non-limiting example in the drawings and are described in additional detail below. It should be understood, however, that the novel aspects of this disclosure are not limited to the particular forms illustrated in the above-enumerated drawings. Rather, the disclosure is to cover modifications, equivalents, combinations, sub-combinations, permutations, groupings, and alternatives falling within the scope of this disclosure as encompassed, for instance, by the appended claims.

### DETAILED DESCRIPTION

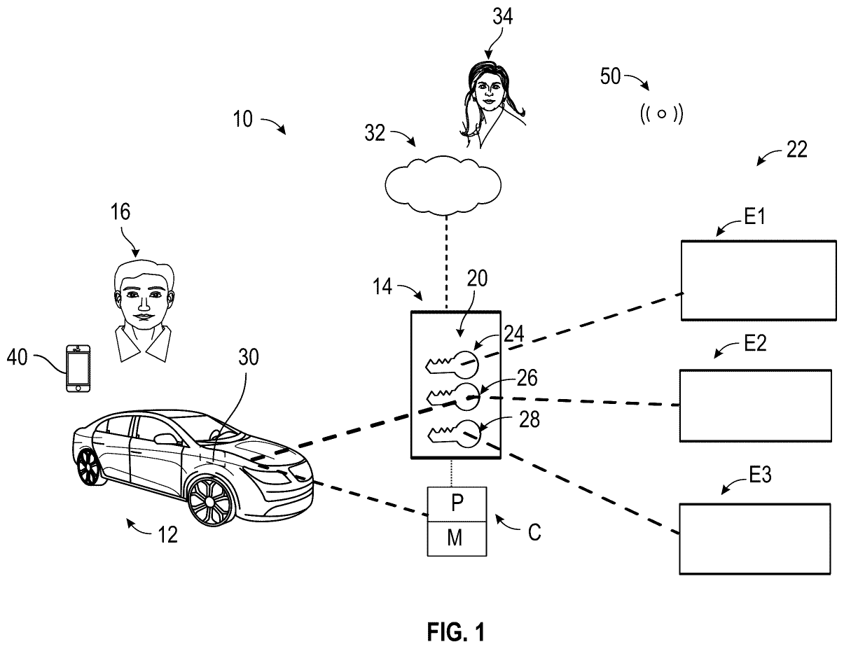

Referring to the drawings, wherein like reference numbers refer to like components, FIG. 1 schematically illustrates an authenticated digital access system 10, referred to hereinafter as system 10, for a vehicle 12. The vehicle 12 may include, but is not limited to, a passenger vehicle, sport utility vehicle, light truck, heavy duty vehicle, minivan, bus, transit vehicle, bicycle, moving robot, farm implement (e.g., tractor), sports-related equipment (e.g., golf cart), boat, plane, train or another moving platform. The vehicle 12 may be an electric vehicle, which may be purely electric or hybrid/partially electric. It is to be understood that the vehicle 12 may take many different forms and have additional components.

Referring to FIG. 1, the vehicle 12 includes a controller C with at least one processor P and at least one memory M (or non-transitory, tangible computer readable storage medium). The memory M can store controller-executable instruction sets, and the processor P can execute the controller-executable instruction sets stored in the memory M.

The proliferation of connected devices and infrastructure has led to an increase in communications between various entities, and the need for device identification and authentication methods. Mobile devices are frequently employed for individual authentication and credential sessions in the communications between entities. This has led to greater cloud and cellular congestion. Additionally, many service providers have developed their own separate authentication and access management protocols. This separation has resulted in disconnected development paths.

As described below, the controller C is adapted to selectively execute a master access platform 14 for authentication and access to a user 16 of the vehicle 12. The master access platform 14 includes a plurality of digital access units 20, referred to herein as “digital keys 20.”

The controller C is adapted to transmit an access request for a predetermined service from a specific ecosystem 22, that is external to the vehicle 12, using the digital keys 20. In some embodiments, the controller C may be adapted to present the digital keys 20 to the ecosystem 22 via a contactless mechanism using infrared radiation, for example. Alternatively, the controller C may be adapted to employ a contact-based mechanism.

The ecosystem 22 may include charging stations, roadside which connects vehicles to transportation infrastructure, and smart home garage systems. The ecosystem 22 may include tolling systems (for collecting road tolls) and parking systems. The ecosystem 22 may include other vehicles. FIG. 1 shows ecosystems E1, E2 and E3. Each ecosystem 22 includes one or more connected devices or IoT devices. As understood by those skilled in the art, the internet of things (IoT) is a network of devices that may communicate with each other and with the cloud using the internet. For example, the connected device in a home ecosystem may include a garage door, wall mount charger, a front door, and a lighting system. The connected device in a smart city ecosystem may include a parking spot.

In the example embodiment according to the current disclosure as shown in FIG. 1, the digital keys 20 include first, second and third digital keys 24, 26, 28. It is understood that the number of digital keys and ecosystems may be varied based on the application(s) at hand. The first digital key 24 is configured to enable access to a predetermined service in an ecosystem E1. The second digital key 26 is configured to enable access to obtain a connectivity service via one or more connected units (e.g., in the vehicle 12). A connected unit refers to a component in the vehicle 12 that can connect to the internet or communicate with other devices, including but not limited to navigation unit, onboard infotainment systems, vehicle diagnostics, and sensors for monitoring vehicle performance. In other examples, the second digital key 26 may be used to access computational and/or digital storage resources, or projection screens on the vehicle 12. In some embodiments, the same (second) digital key 26 may be employed to enable access to the vehicle 12 as well as ecosystem E2. Referring to FIG. 1, a third digital key 28 may be employed to enable access to a another predetermined service in another ecosystem E3.

The respective access privileges of the digital keys 20 in the master access platform 14 is verified based in part on at least one metadata entry. In communication systems, “metadata” refers to information about a communication, such as the sender, receiver, date, time, and location of a message, rather than the actual content of the message itself.

In some embodiments, the master access platform 14 may be automatically activated when the vehicle 12 is in operation. Alternatively, the master access platform 14 may be selectively activated based on a request from the user 16, for example, through a user interface 30 in the vehicle 12. The user 16 may be a driver or a passenger of the vehicle 12. The user interface 30 may include a touchscreen or other IO device and may be incorporated in the dashboard, overhead visor (not shown), or other suitable location in the vehicle 12. In some embodiments, the master access platform 14 is executable by a respective controller in each individual vehicle. In a fleet, the master access platform 14 may be executable by a controller in a master vehicle.

The system 10 utilizes a (central) certification authority 32 for managing multiple credentials. As described below, the controller C is adapted to receive a basic vehicle certificate from a certification authority 32 during an initial vehicle pairing. The certification authority 32 operates as the back office, managing the overall certification process. The certification authority 32 may be a cloud one or more servers hosted on the Internet to store, manage, and process data. The certification authority 32 may be manned electronically and/or by an administrator 34 having access to an electronic device such as a desktop computer, laptop, tablet, cell phone or wearable device. The certification authority 32 may be a private or public entity maintained by an organization.

The system 10 provides an effective way of simplifying communications, omitting various elements while retaining their function. The vehicle 12 does not have to rely on external entities for credentialing on authentication for every transaction of an external ecosystem. This is particularly advantageous when the vehicle 12 is out in a remote area with limited connectivity. For example, prior to a journey, the vehicle 12 may obtain the authorization through the master access platform 14 while at home or other familiar surroundings with abundant connectivity. Additionally, this reduces latency experienced by the user 16 as the pre authentications have already been completed when the user 16 wishes to access an ecosystem.

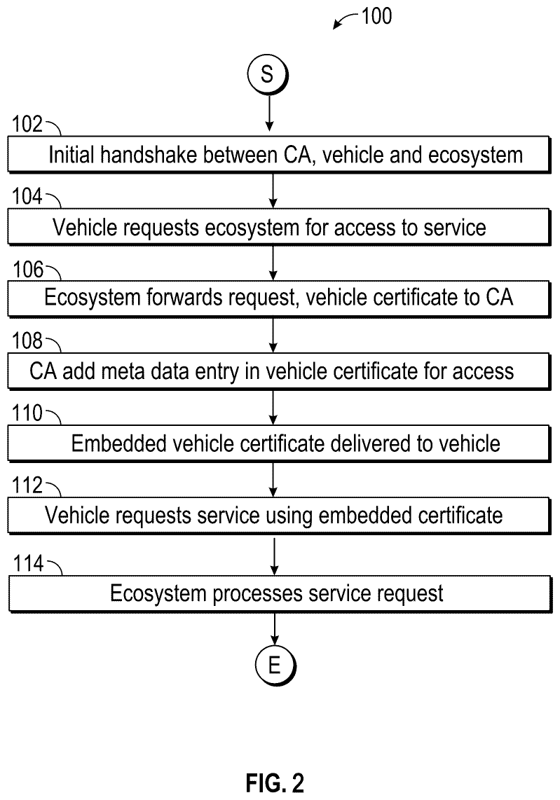

Referring now to FIG. 2, a flowchart of an example method 100 of operating the system 10 in accordance with a first embodiment is shown. Method 100 may be embodied as computer-readable code or instructions stored on and at least partially executable by the controller C. The certification authority 32 and the ecosystem 22 may include respective processors and respective tangible, non-transitory memory on which instructions are recorded for executing components of the method 100. Method 100 need not be applied in the specific order recited herein. Furthermore, it is to be understood that some blocks or steps may be eliminated.

Beginning at block 102, an initial pairing and handshake occurs between the certification authority 32, the vehicle 12 and the ecosystem 22. During the initial vehicle pairing, during which the controller C receives a basic vehicle certificate, establishing its unique vehicle identification.

Advancing to block 104, the controller C requests for access to a specific or predefined service provided by the ecosystem 22, signing the request with the basic vehicle certificate obtained in block 102. Proceeding to block 106, upon receiving this request, the ecosystem 22 forwards the basic vehicle certificate to the certification authority 32, including additional parameters such as the specific service access requirements and expiration date for the authorization.

Advancing to block 108, the certification authority 32 inserts at least one metadata entry in the vehicle certificate, incorporating access to a particular service from a particular ecosystem with an expiration date. The certification authority 32 processes this information by inserting the new access data into its certification system and generating an updated vehicle certificate. This enhanced certificate effectively embeds the new authorization details.

Proceeding to block 110, the embedded vehicle certificate is delivered from certification authority 32 to the ecosystem 22, and from the ecosystem 22 to the controller C. The certification authority 32 then returns this updated certificate to the ecosystem 22, who forwards it to the requesting vehicle 12. During future interactions, the controller C is adapted to presents its enhanced vehicle certificate, which now contains the embedded authorization information, including specific service access permissions and expiration dates.

Advancing to block 112, the controller C requests access to a particular service from a particular ecosystem, the request being accompanied or signed with the embedded vehicle certificate. The controller C may employ the embedded vehicle certificate multiple times prior to the expiration period. Proceeding to block 114, the ecosystem 22 processes the request to check if the embedded vehicle certificate is valid and contains proper authorization in metadata. The ecosystem 22 may then validate both the authenticity of the basic certificate and the embedded authorization details to grant appropriate access.

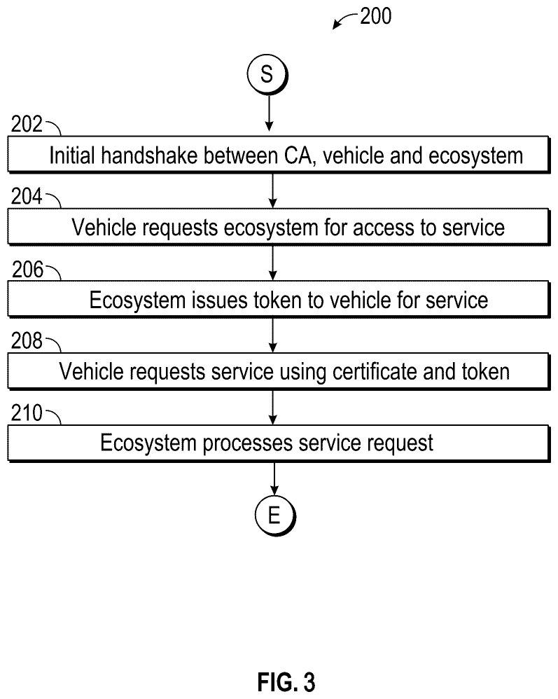

Referring now to FIG. 3, a flowchart of an example method 200 of operating the system 10 in accordance with a second embodiment is shown. Method 200 may be embodied as computer-readable code or instructions stored on and at least partially executable by the controller C, the certification authority 32 and the ecosystem 22. Method 200 need not be applied in the specific order recited herein. Furthermore, it is to be understood that some blocks or steps may be eliminated.

The second embodiment implements a token-based approach where the involvement of the certification authority 32 is limited to the initial pairing process. Subsequently, the controller C and service provider conduct dynamic exchanges during authentication as needed. Beginning at block 202, an initial pairing and handshake occurs between the certification authority 22, the vehicle 12 and the ecosystem 22. The certification authority 32 operates as the back office, managing the overall certification process. During the initial vehicle pairing, the controller C receives a basic vehicle certificate establishing its unique vehicle identification.

Proceeding to block 204, the controller C requests for access to a specific service (e.g., requesting charging or a parking spot) to the ecosystem 22, signing the request with the basic vehicle certificate obtained in block 102. Advancing to block 206, the ecosystem 22 issues a token to the vehicle 12 for the predetermined service with an expiry date. The ecosystem 22 inserts at least one metadata entry in the token, incorporating specific service access permissions and an expiration date. During future interactions, the controller C in the vehicle 12 is adapted to present the token, which now contains the embedded authorization information.

Proceeding to block 208, the controller C requests access to a particular service from a particular ecosystem, the request being accompanied by the token. The controller C may employ the token multiple times prior to the expiration period. Advancing to block 210, the ecosystem 22 processes the request to determine if the basic vehicle certificate is valid and the token contains proper authorization. The process is rendered faster and smoother as a result.

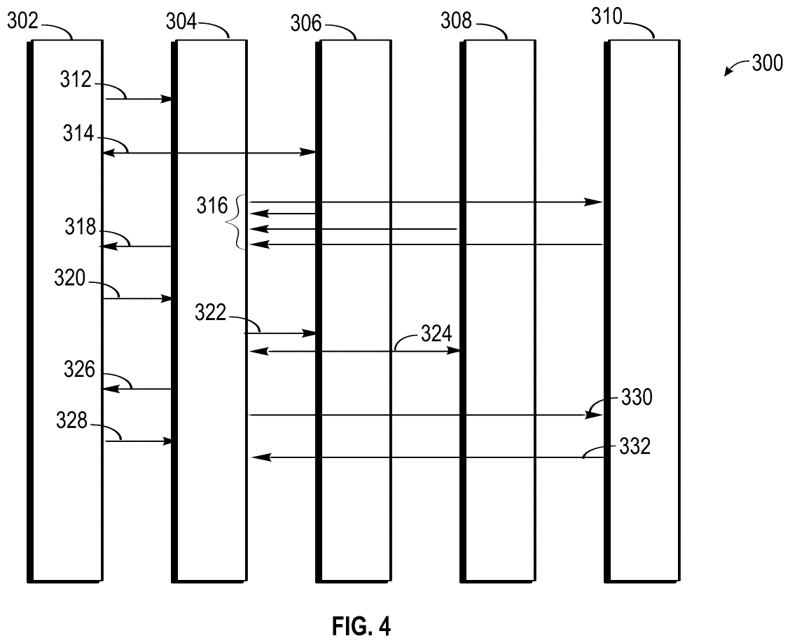

In some embodiments, the master access platform 14 may communicate with external entities in accordance with a publish-subscribe messaging protocol. FIG. 4 is a schematic diagram of the interactions in an example publish-subscribe set-up 300. The external entities here are the master access platform 302 (executed by controller C), a broker 304, a vehicle fleet server 306, an ecosystem or service provider 308 and a provider back office/server 310. The broker 304 is an external entity that facilitates the selection of the service desired by the vehicle 12 and the resources that the vehicle 12 can offer to the ecosystems.

Referring to FIG. 4, the events (indicated by arrows) are arranged in descending order of time, starting with the earliest events. In one example, the publish-subscribe messaging protocol is Message Queue Telemetry Transport (MQTT). The term “MQTT” includes variations and updates of MQTT. MQTT is a bi-directional communication protocol that allows the client devices and server application to become decoupled. The publish-subscribe messaging protocol may use an encryption model with certificate, username and password protected connections.

Referring to FIG. 4, as indicated by arrow 312, the master access platform 302 first publishes its selection of a particular service or ride intention to the broker 304. As indicated by arrow 314, the broker 304 advertises the topic to the vehicle fleet server 306 and provides feedback on subscriptions to the master access platform 302. Arrow group 316 show a sequence of acknowledgement requests for the subscribed topic along with the decision response. Per arrow 318, the broker 304 provides a list of subscribers to the master access platform 302. Per arrow 320, the master access platform 302 sends its decision to the broker 304.

Referring to arrow 322 in FIG. 4, the broker 304 prepares a digital key exchange with the vehicle fleet server 306. Per arrows 324, 326, a secure digital key exchange is carried out between the service provider 308, broker 304 and vehicle fleet server 306. As indicated by arrow 328, the master access platform 302 confirms receipt of the digital key. Per arrows 330, 332, the broker 304 sends information documenting the transaction to the provider back office/server 310, which in turn, acknowledges receipt of this information.

The controller C may select between multiple options for the same application or service. The broker 304 provides a list of subscription suggestions, and from there, the controller C is adapted to determine the best choice. The controller C may employ a credential selection decision tree to guide that selection process. The decision tree may employ weighting factors for each option.

The credential selection may be performed dynamically for different categories of ecosystem involvement, e.g., directly involved, partially involved and new request. The first category involves direct participation. In this scenario, there is a direct requirement for resources from a specific ecosystem that the master access platform 14 is subscribed to, e.g., a monthly charging account. The master access platform 14 is already engaged, for example, it arrives at a charging station, uses the digital keys 20 and gains access. The second category may involve applications from users in vehicles with bring-your-own-device scenarios. For example, referring to FIG. 1, a user 16 may have a personal device 40 that can leverage these ecosystems. In this case, the vehicle 12 has a partial involvement. The personal device 40 attaches to the master access platform 14 using internal pairing mechanisms and relies on the master access platform 14 provided by the vehicle 12. The third category involves a completely new ecosystem interaction. Here, the vehicle 12 has never interacted with this charging context before. Even in this case, the vehicle 12 may employ a digital key with new metadata to make a reservation request. Leveraging such ecosystems may be accomplished through specific preferences and available options.

The system 10 has the technical advantage of allowing the vehicle 12 to serve as an ecosystem platform capable of distributing resources. For example, prior to starting a trip, the user 16 may obtain information from the broker regarding what ecosystems are available. The system 10 allows the controller C to publish an intent and the broker 304 advertising the topic, indicating whether the vehicle 12 is seeking or providing resources. In other words, the exchange of resources may be bi-directional, e.g., a vehicle with an abundance of charge may transfer electric charge to a charging station. This communication is transmitted to the vehicle fleet server 306 for acknowledgment, confirming the available resources. It simultaneously communicates with the provider back office/server 310 to ensure that the service provider 308 is ready for the service. This allows the service provider 308 to communicate separately with the provider back office/server 310, so the master access platform 14 need not concern itself with those details. Once acknowledgment for a given topic is received, the master access platform 14 may implement access control.

Another example scenario is described herein where a vehicle 12 and an electrical charging ecosystem are engaged in a negotiation. In this example, the vehicle 12 while parked during routine activities like grocery shopping, has sufficient charge to donate back to the grid. The vehicle 12 requires access to the parking area to enable its energy contribution to the charging infrastructure. The system 10 enables pre-authentication with multiple ecosystems to facilitate this interaction. In this complex scenario, three distinct ecosystems (vehicle 12, parking area and charging infrastructure) are simultaneously at play. Here, the vehicle 12 operates both as a device and as an ecosystem platform, demonstrating its multifaceted capabilities. Beyond the energy exchange, the vehicle 12 may leverage additional resources such as nearby roadside unit (RSU) for various vehicular applications.

In summary, the system 10 makes it more efficient for different ecosystems to be accessed by a vehicle 12. The process operates through a structured system where the controller C obtains pre-authentication credentials from the certification authority 32 stored in its payload. An initial pairing occurs between the vehicle 12 and various service ecosystems. Both the vehicle 12 and the ecosystem 22 may maintain signed certificates for verification purposes. When dynamic changes are needed, such as accessing new applications or ecosystems, the metadata may be modified while the initial signed key (referred to here as a basic vehicle certificate) remains constant. New signed certificates are distributed to both the vehicle 12 and the service provider/ecosystem 22, and authentication occurs through proper validation of this metadata.

Referring to FIG. 1, the various components of the system 10 may communicate via a wireless network 50, which may be a short-range network or a long-range network. The wireless network 50 may be a serial communication bus in the form of a local area network. The local area network may include, but is not limited to, a Command unit Area Network (MAY), a Command unit Area Network with Flexible Data Rate (MAY-FD), Ethernet, Bluetooth, WIFI and other forms of data. The wireless network 50 may be a Wireless Local Area Network (LAN) which links multiple devices using a wireless distribution method, a Wireless Metropolitan Area Network (MAN) which connects several wireless LANs or a Wireless Wide Area Network (WAN) which covers large areas such as neighboring towns and cities. Other types of network technologies or carrier systems available to those skilled in the art may be employed.

As used herein, the terms ‘dynamic’ and ‘dynamically’ describe steps or processes that are executed in real-time and are characterized by monitoring or otherwise determining states of parameters and regularly or periodically updating the states of the parameters during execution of a routine or between iterations of execution of the routine.

The controller C of FIG. 1 includes a computer-readable medium (also referred to as a processor-readable medium), including a non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which may constitute a main memory. Such instructions may be transmitted by one or more transmission media, including coaxial cables, copper wire and fiber optics, including the wires that comprise a system bus coupled to a processor of a computer. Some forms of computer-readable media include, for example, a floppy disk, a flexible disk, hard disk, magnetic tape, other magnetic medium, a CD-ROM, DVD, other optical medium, a physical medium with patterns of holes, a RAM, a PROM, an EPROM, a FLASH-EEPROM, other memory chip or cartridge, or other medium from which a computer can read.

Look-up tables, databases, data repositories or other data stores described herein may include various kinds of mechanisms for storing, accessing, and retrieving various kinds of data, including a hierarchical database, a set of files in a file system, an application database in a proprietary format, a relational database energy management system (RDBMS), etc. Each such data store may be included within a computing device employing a computer operating system such as one of those mentioned above and may be accessed via a network in one or more of a variety of manners. A file system may be accessible from a computer operating system and may include files stored in various formats. An RDBMS may employ the Structured Query Language (SQL) in addition to a language for creating, storing, editing, and executing stored procedures, such as the PL/SQL language mentioned above.

The flowcharts illustrate an architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by specific purpose hardware-based systems that perform the specified functions or acts, or combinations of specific purpose hardware and computer instructions. These computer program instructions may also be stored in a computer-readable medium that can direct a controller or other programmable data processing apparatus to function in a particular manner, such that the instructions stored in the computer-readable medium produce an article of manufacture including instructions to implement the function/act specified in the flowchart and/or block diagram blocks.

The numerical values of parameters (e.g., of quantities or conditions) in this specification, including the appended claims, are to be understood as being modified in each respective instance by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of each value and further divided ranges within the entire range. Each value within a range and the endpoints of a range are hereby disclosed as separate embodiments.

The detailed description and the drawings or FIGS. are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. A system of authenticated digital access for a vehicle, the system comprising:
a controller installed in the vehicle, the controller having a processor and tangible, non-transitory memory on which instructions are recorded;
wherein the controller is adapted to selectively execute a master access platform for vehicle authentication and providing user access, the master access platform including a first digital key and a second digital key;
wherein the first digital key is configured to enable access to a predetermined service in at least one ecosystem external to the vehicle;
wherein the second digital key is configured to enable access to at least one connected unit in the vehicle; and
wherein respective access privileges of each digital key in the master access platform are verified based in part on at least one metadata entry.

2. The system of claim 1, wherein the second digital key is configured to enable access to a second predetermined service in a second ecosystem external to the vehicle.

3. The system of claim 1, wherein the at least one ecosystem includes at least one of a charging station, a road-side unit, and a tolling system.

4. The system of claim 1, wherein the at least one ecosystem includes at least one of a smart home garage system, and a parking system.

5. The system of claim 1, wherein the at least one ecosystem includes another vehicle.

6. The system of claim 1, wherein the controller is adapted to:
receive a basic vehicle certificate from a certification authority during an initial vehicle pairing; and
transmit an access request for the predetermined service to the at least one ecosystem with the basic vehicle certificate, the access request including the predetermined service from the at least one ecosystem.

7. The system of claim 6, wherein the controller is adapted to:
receive an embedded vehicle certificate from the at least one ecosystem, the at least one ecosystem having forwarding the basic vehicle certificate to the certification authority with access requirements for the predetermined service valid up to an expiration date; and
present the embedded vehicle certificate for future interactions with the at least one ecosystem up to the expiration date, the embedded vehicle certificate including the at least one metadata entry inserted by the certification authority incorporating the predetermined service and the expiration date.

8. The system of claim 6, wherein the controller is adapted to:
receive a token issued by the at least one ecosystem, the token including a metadata entry inserted by the at least one ecosystem incorporating the predetermined service and an expiration date; and
present the token for future interactions with the at least one ecosystem up to the expiration date.

9. The system of claim 6, wherein the controller is adapted to:
communicate with a broker in accordance with a publish-subscribe messaging protocol; and
select the predetermined service from a list of subscription suggestions provided by the broker.

10. The system of claim 9, wherein the publish-subscribe messaging protocol includes Message Queue Telemetry Transport (MQTT).

11. The system of claim 9, wherein the controller is adapted to employ a credential selection for the at least one ecosystem based in part on an involvement level of the at least one ecosystem, the involvement level including direct involvement and partial involvement.

12. The system of claim 1, wherein the controller is adapted to present the first digital key to the at least one ecosystem via a contactless mechanism.

13. A method for authenticated digital access in a vehicle having a controller with a processor and tangible, non-transitory memory on which instructions are recorded, and at least one connected unit adapted to interface with the controller, the method comprising:
selectively executing a master access platform for vehicle authentication and providing user access, the master access platform including a first digital key and a second digital key;
obtaining access to a predetermined service in at least one ecosystem external to the vehicle through the first digital key;
obtaining access to the at least one connected unit through the first digital key; and
verifying respective access privileges of each digital key in the master access platform based in part on at least one metadata entry.

14. The method of claim 13, further comprising:
receiving a basic vehicle certificate from a certification authority during an initial vehicle pairing, via the controller; and
transmitting an access request for the predetermined service to the at least one ecosystem with the basic vehicle certificate, via the controller, the access request including the predetermined service from the at least one ecosystem.

15. The method of claim 14, further comprising:
receiving an embedded vehicle certificate from the at least one ecosystem, via the controller, the at least one ecosystem having forwarding the basic vehicle certificate to the certification authority with access requirements for the predetermined service valid up to an expiration date; and
presenting the embedded vehicle certificate for future interactions with the at least one ecosystem up to the expiration date, via the controller, the embedded vehicle certificate including the at least one metadata entry inserted by the certification authority incorporating the predetermined service and the expiration date.

16. The method of claim 14, further comprising:
receiving a token issued by the at least one ecosystem, via the controller, the token including a metadata entry inserted by the at least one ecosystem incorporating the predetermined service and an expiration date; and
presenting the token for future interactions with the at least one ecosystem up to the expiration date, via the controller.

17. The method of claim 14, further comprising:
communicating with a broker in accordance with a publish-subscribe messaging protocol, via the controller; and
selecting the predetermined service from a list of subscription suggestions provided by the broker, via the controller.

18. The method of claim 17, further comprising:
selecting the publish-subscribe messaging protocol to include Message Queue Telemetry Transport (MQTT).

19. A vehicle comprising:
a controller having a processor and tangible, non-transitory memory on which instructions are recorded;
at least one connected unit adapted to interface with the controller;
wherein the controller is adapted to selectively execute a master access platform for vehicle authentication and providing user access, the master access platform including a first digital key and a second digital key;
wherein the first digital key is configured to enable access to a predetermined service in at least one ecosystem external to the vehicle;
wherein the second digital key is configured to enable access to the at least one connected unit; and
wherein respective access privileges of each digital key in the master access platform are verified based in part on at least one metadata entry.

20. The vehicle of claim 19, wherein the at least one ecosystem includes at least one of a charging station, a road-side unit, a tolling system, a smart home garage system, and a parking system, and another vehicle.
